(19) United States
(12) Patent Application Publication
(10) Pub. No.: US 2024/0123846 A1
(43) Pub. Date: Apr. 18, 2024

(54) ELECTRIC VEHICLE CHARGE CONNECTOR

(71) Applicant: Black & Decker, Inc., New Britain, CT (US)

(72) Inventors: MICHELLE KOKES, Towson, MD (US); STEVEN DERBY, Towson, MD (US); JESSE ESCOBEDO, Towson, MD (US); BROCK CANFIELD, Towson, MD (US); JAY PATEL, Towson, MD (US)

(21) Appl. No.: 18/381,290

(22) Filed: Oct. 18, 2023

Related U.S. Application Data
(60) Provisional application No. 63/417,160, filed on Oct. 18, 2022.

(51) Int. Cl. B60L 53/16; B60L 53/302

(52) U.S. Cl. CPC B60L 53/16; B60L 53/302

(57) ABSTRACT

In a first aspect, the present invention provides a motor, fan and filter arrangement for a vacuum cleaner, comprising: a motor (10); a fan (20) connected to an output shaft (12) of the motor and having an axial intake; and a filter (30, 230, 330); wherein the fan (20) is arranged with its axial intake facing the motor (10); and the motor (10) is housed within the filter (30, 230, 330). Such an arrangement makes much more efficient use of space than a conventional arrangement and allows the motor to be positioned within the filter in a reversed direction in comparison to conventional arrangements, so that clear air from the filter can be drawn over the motor before encountering the fan. This also has the beneficial side-effect of cooling the motor with the filtered air. In a second aspect, the present invention also provides vacuum cleaners (100, 200, 300) comprising such a motor, fan and filter arrangement. Preferred embodiments of such vacuum cleaners are described, including a pivotable stick vac and different hand-holdable vacuum cleaners.

### CROSS-REFERENCE TO RELATED APPLICATION

This application claims the benefit of U.S. Provisional Application No. 63/417,160, file on Oct. 18, 2022. The entire disclosure of the application referenced above is incorporated by reference herein.

### FIELD OF THE INVENTION

The present invention is directed to an electric charger for vehicles and equipment.

### SUMMARY OF THE INVENTION

Electric chargers are de-ices used to recharge the batteries of electric vehicles (EVs). Not only can these chargers be used passenger cars, but they can be used to charge any vehicle or device using large batteries, such commercial riding mowers, utility vehicles, snow blowers and other power tools. Electric chargers can be installed at home, in public charging stab OM, or at workplaces, and are essential for the widespread adoption of battery powered vehicles and tools. The present invention is directed to an electric charger that is easy to store and easy to transport.

### BRIEF DESCRIPTION OF THE INVENTION

Further features and advantages of the present invention will be better understood by reference to the following description, which is given by way of example and in association with the accompanying drawings, in which:

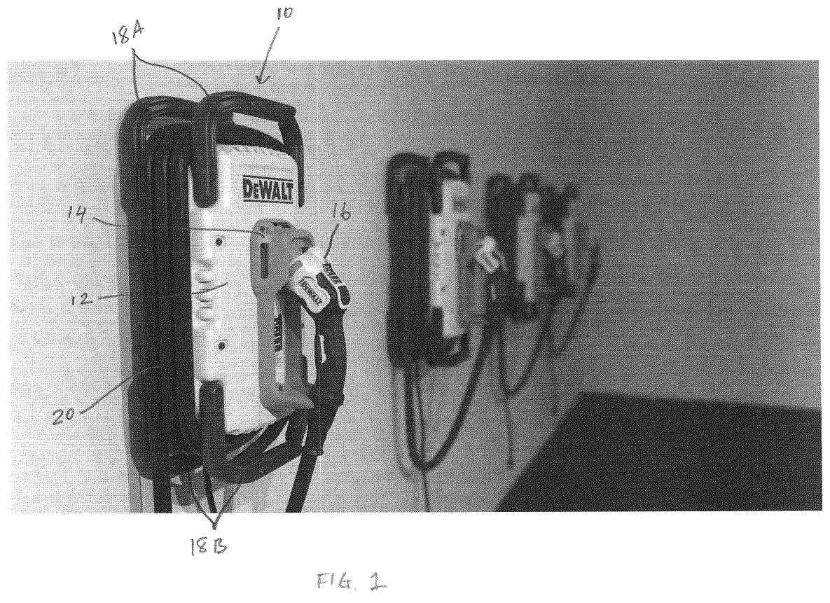

FIG. 1 is a view of a charger of the present invention mounted on a wall;

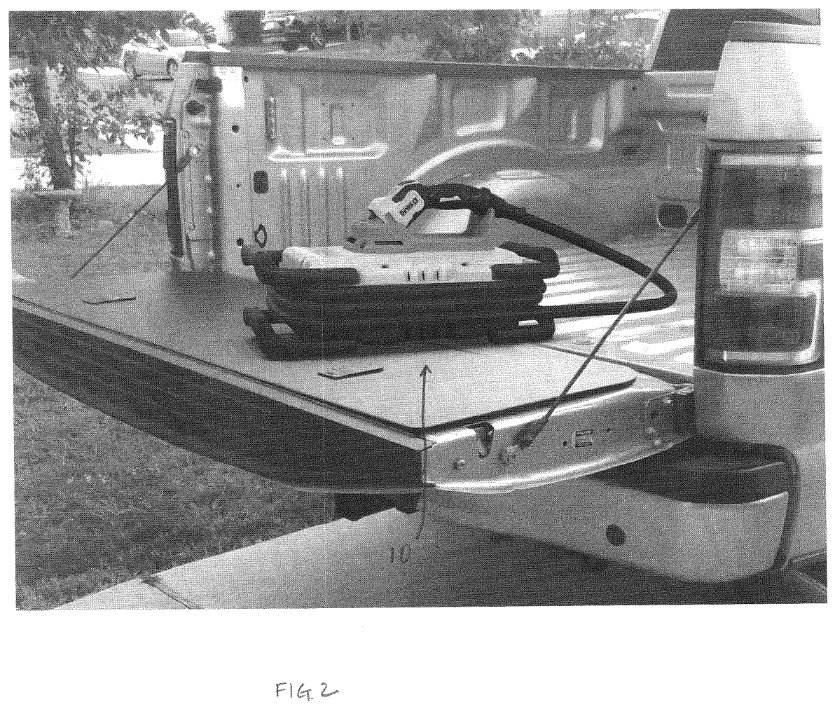

FIG. 2 is the charger of the present invention placed in the bed of a pickup truck;

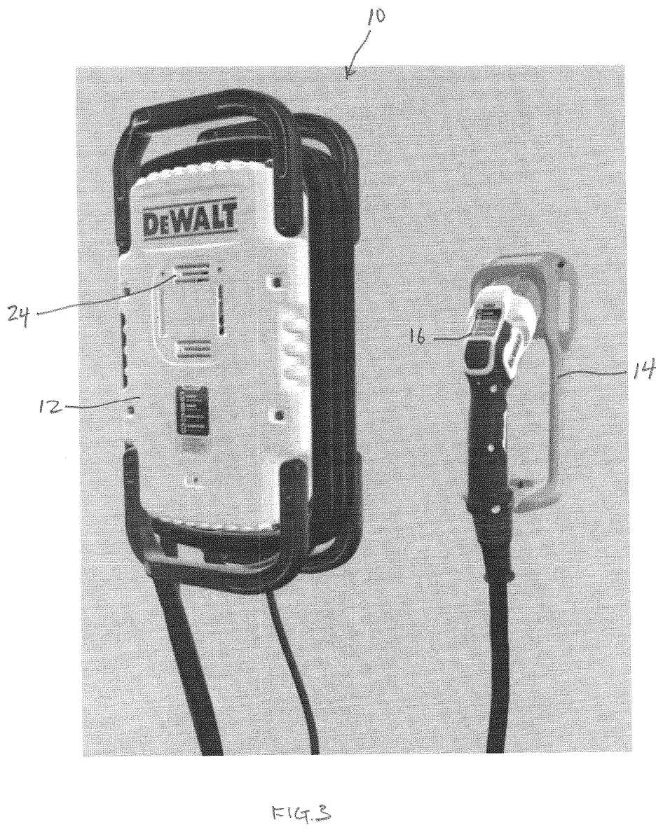

FIG. 3 is the charger of the present invention with the dock removed:

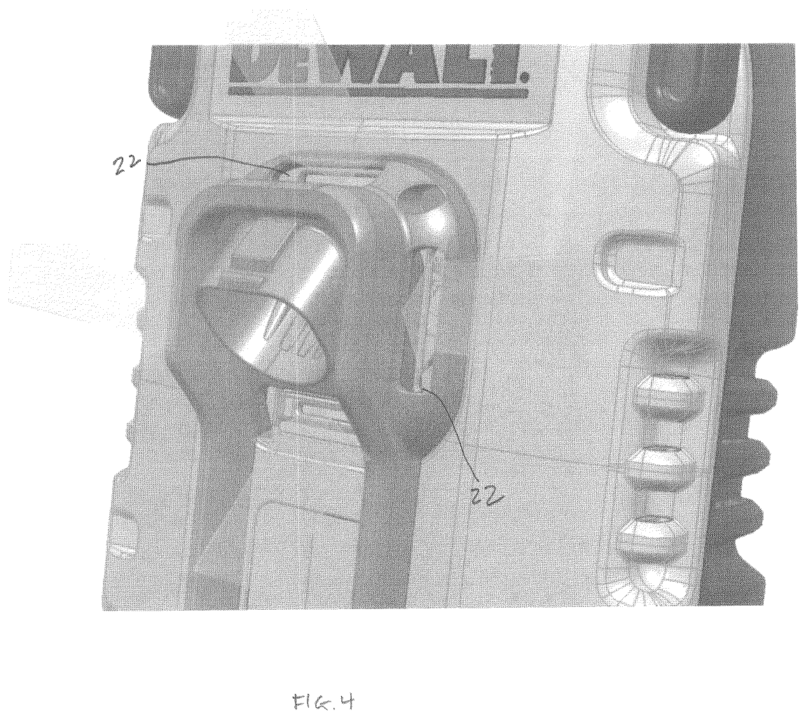

FIG. 4 is close up image of the air vents in the dock;

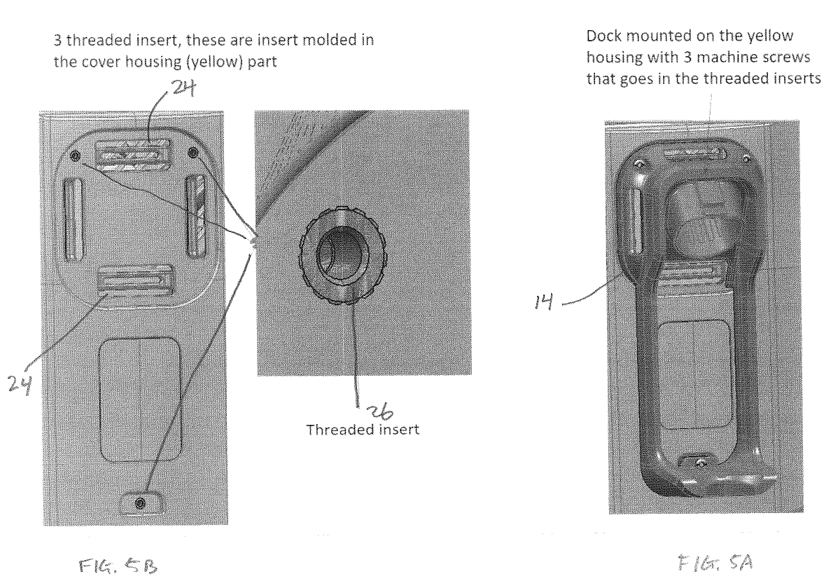

FIG. 5A shows the dock mounted on the charger; and

FIG. 5B shows a front face of the charger.

### DETAILED DESCRIPTION OF THE INVENTION

The following description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

Referring to FIG. 1, a series of chargers 10 are shown mounted on a wall. The chargers are used to supply electrical charge to batteries that can be used on a variety of tools. These types of chargers are normally used to charge large capacity batteries used on vehicles or other large power equipment such as riding mowers, snow blowers, utility vehicles and other similar products. In a preferred embodiment, the chargers are for use on riding mowers.

The chargers is made up of a main housing 12 and includes a dock 14 for a electric plug 16 that connects the mower. An electrical cable 20 connects the plug 16 to the housing 12.

The housing further include a pair of brackets 18A and 18B located at the top and bottom of the housing, respectively, for holding the cable when it is to be stored. The dock 14 provides a cradle for securing the plug 16 when not in use.

One of the benefits of the chargers is that it's portable and can be easily removed from the wall. The rear of the housing 12 can includes keyhole slots that can be easily attached onto a mounting bracket secured to the wall. Any suitable attachment mechanism can be used with the charger so long as a user can quickly and easily attach the charger to the wall.

The charger 10 can be connected to any standard outlet in a home, garage or other location to provide power to the charger 10. For example, in the U.S. a 110V or 120V outlet is typical.

FIG. 2 shows the charger 10 in the bed of a pickup truck. The rear brackets 18A and 18B provide a flat surface so that the charger can be transported easily. A user simply needs to find a power source to plug in the charger 10, which can be provide by an outlet or a generator at a worksite.

Another benefit of the charger 10 is that the dock can be separated from the housing 12, and mounted separately. For example, if the charger 10 is secured to a wall in a first location, for instance to be near an outlet, but the user normally uses the plug 16 in a second location, he can mount the dock 14 in the second location. See for example FIG. 3 which shows the dock 14 mounted adjacent the charger housing 12.

FIG. 3 shows a front of the charger housing 12 having vent holes 24 to cool the internal components of the charger. The dock includes air gaps 22, which helps air can enter the charger housing 12.

FIGS. 5A and 5B show several threaded inserts on the housing 12, which correspond holes 28 in the dock for screws. To remove the dock 14 from the charger 10, a user can simply remove the screws and use the holes 28 to secure the dock 14 in another location, such as a wall.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

1. A charger, comprising:
a housing;
a plug for connecting the charger to battery;
the housing having brackets for storing a charging cable connected to the plug; and
a dock removably secured to the housing, the dock securing the plug.

2. The charger of claim 1, wherein the brackets form a loop with an opening therein, the opening allowing a user to grasp the loop for easy transportation.

3. The charger of claim 1, wherein the brackets comprise a first set of brackets at a top portion of the housing and a second set of brackets at a bottom portion of the housing.

4. The charger of claim 3, wherein the first set of brackets and the second set of brackets form a loop for a user to grasp.

5. The charger of claim 3 wherein the first set of brackets comprise a front bracket and a rear bracket, and the second set of brackets comprise a front bracket and a rear bracket.

6. The charger of claim 5, wherein the rear bracket of both the first set of brackets and the second set of brackets are flush with a rear portion of the housing.

7. The charger of claim 1, wherein the housing include vent holes to allow the passage of air, and the dock is located over the vent, holes.

8. The charger of claim 7, where in dock includes air gaps in fluid communication with the vent holes.
